(19) United States
(12) Patent Application Publication
(10) Pub. No.: US 2009/0095181 A1
(43) Pub. Date: Apr. 16, 2009

(54) Transfer Drum Between Printing Units of a Sheet-Fed Printing Press

(75) Inventors: Henri Festa, Heidelberg (DE); Thomas Schmidt, Eppelheim (DE)

Correspondence Address: LERNER GREENBERG STEMER LLP, P O BOX 2480, HOLLYWOOD, FL, 33022-2480, US

(73) Assignee: HEIDELBERGER DRUCKMASCHINEN AG, Heidelberg (DE)

(21) Appl. No.: 12/251,701

(22) Filed: Oct. 15, 2008

(30) Foreign Application Priority Data
Oct. 15, 2007 (DE) 10 2007 049 378.0

(51) Int. Cl. B41F 21/10

(52) U.S. Cl. 101/409

(57) ABSTRACT

A transfer drum for conveying a sheet in a printing press improves the accuracy of a sheet transfer. The transfer drum includes a drum body which is supported for rotation in a frame and a gripper system on the drum body for holding an edge of the sheet. The gripper system is formed of a row of spaced-apart gripper fingers jointly pivotable about an axis which is parallel to the axis of rotation of the drum body. A device for actuating the gripper fingers during a revolution of the drum body includes an actuating element which is displaceable in the direction of the axis and on which at least two drive elements of cam joints are formed. Each of the drive elements is in operative connection with a group of the gripper fingers.

### CROSS-REFERENCE TO RELATED APPLICATION

This application claims the priority, under 35 U.S.C. §119, of German Patent Application DE 10 2007 049 378.0, filed Oct. 15, 2007; the prior application is herewith incorporated by reference in its entirety.

### BACKGROUND OF THE INVENTION

### Field of the Invention

The invention relates to a transfer drum for conveying a sheet between printing units of a sheet-fed printing press, including a drum body supported for rotation in a frame, a gripper system disposed on the drum body for holding an edge of the sheet and formed of a row of spaced-apart gripper fingers jointly pivotable about an axis parallel to an axis of rotation of the drum body, and a device for actuating the gripper fingers during a revolution of the drum body.

Transfer drums with gripper systems for holding a sheet at a sheet edge are used to convey a sheet through a printing press. A gripper system is formed of a plurality of gripper fingers disposed on a gripper shaft and cooperating with other gripper fingers or gripper pads. In order to open or close the grippers, the gripper shaft is supported on the drum body so as to pivot about an axis which is parallel to the axis of rotation of the transfer drum. The pivoting movement is carried out through the use of a gear mechanism. When a cam gear mechanism is used, the gripper shaft is connected to a roller lever, and a cam roller supported on the roller lever interacts with a cam which is fixed to the frame. In order to ensure that a printed image has a desired position on a sheet, the grippers need to hold the gripper edge in a reproducible and accurate way. The gear mechanisms controlling the grippers are constructed in such a way that the grippers carry out a suitable movement when the transfer drum is in a rotary position in which the grippers receive a sheet. If cam gear mechanisms are used, it is necessary for the cam roller to contact the contact surface of the cam when the transfer drum is in the aforementioned positions. The edge of the sheet is held between the gripper fingers or between gripper finger and gripper pad in a friction-locking and/or form-locking manner. A form-locking connection is one which connects two elements together due to the shape of the elements themselves, as opposed to a force-locking connection, which locks the elements together by force external to the elements. The holding forces are generated by springs which are compressed when the grippers close. In that process, the gripper shaft is subject to torsion.

If a torque to open and close grippers is introduced on one side of a gripper shaft, the grippers must be set to open and close at the same instant because of the torsion of the gripper shaft. In order to reduce the effects of torsion of the gripper shaft, German Published, Non-Prosecuted Patent Application DE 35 08 697 A1, corresponding to U.S. Pat. No. 4,759,290, discloses a device for introducing the torque at the center of the gripper shaft. In order to do so, however, additional gearing elements are required.

German Patent DE 199 47 538 C1 discloses a gripper system wherein a cam support, which is in engagement with a roller disposed on a roller lever, is disposed to be stationary on one end of a gripper shaft. The roller lever and a further roller lever are supported in a stationary pivot joint. A roller on the second roller lever is in functional connection with a control cam. Due to the high number of gearing elements, the device uses a lot of raw materials and is costly because the gearing elements need to be rigid to be able to introduce a high torque at the end of the gripper shaft.

German Published, Non-Prosecuted Patent Application DE 19 08 181 A1, corresponding to U.S. Pat. No. 3,650,211, discloses a resilient clamping gripper wherein gripper fingers are supported to pivot in a pivot joint which is parallel to a gripper shaft. If the gripper shaft is rotated to actuate the grippers, the pivot joint moves along a circular path having a center which is a gripper finger tip resting on a gripper pad. In order to rotate the gripper shaft, a torque is introduced on one side of the gripper shaft in a conventional way.

### SUMMARY OF THE INVENTION

It is accordingly an object of the invention to provide a transfer drum between printing units of a sheet-fed printing press, which overcomes the hereinafore-mentioned disadvantages of the heretofore-known devices of this general type and which improves accuracy of a sheet transfer.

With the foregoing and other objects in view there is provided, in accordance with the invention, a transfer drum for conveying a sheet in a printing press. The transfer drum comprises a drum body being supported for rotation in a frame and having an axis of rotation. A gripper system is disposed on the drum body for holding an edge of the sheet. The gripper system is formed of a row of spaced-apart gripper fingers jointly pivotable about an axis parallel to the axis of rotation of the drum body. A device for actuating the gripper fingers during a revolution of the drum body includes an actuating element displaceable in direction of the axis to open and close the gripper fingers, and cam joints having at least two drive elements formed on the actuating element. Each of the drive elements is in operative connection with a respective group of the gripper fingers.

In accordance with another feature of the invention, the invention can be used to particular advantage with a pliers-type gripper system on a reversing or turning drum wherein gripper fingers interacting in pairs are attached to a gripper tube and are supported to rotate about the axis of the gripper tube. The gripper tube is coaxial with an actuating shaft. An axial displacement of the actuating shaft causes the cam joint to press the gripper fingers together against the force of a pre-tensioned spring. The axial forces which occur in the process are absorbed by an axial bearing between the cam joint and the gripper tube. Due to the fact that the gripper fingers support each other, no torsion occurs on the shaft/tube system when the grippers close.

In accordance with a further feature of the invention, there are provided output elements which may be cam elements that are in contact with cam rollers connected to the actuating elements.

In accordance with an added feature of the invention, each cam element has two regions of different cam gradients. A first cam region causes the gripper fingers to close quickly. A second cam region is constructed in such a way that high gripper closing forces are attained.

In accordance with an additional feature of the invention, at least one spring, which keeps the elements of the cam joint in contact and causes the grippers to open, is provided for each group of grippers which are jointly or commonly driven.

In accordance with a concomitant feature of the invention, the actuating element is coupled to an output element of an axial cam joint. The output element may be a cam roller which a spring keeps in contact with an axial cam that is fixed to the frame.

Other features which are considered as characteristic for the invention are set forth in the appended claims.

Although the invention is illustrated and described herein as embodied in a transfer drum between printing units of a sheet-fed printing press, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a fragmentary, diagrammatic front-elevational view of a sheet-guiding drum including a device for controlling grippers;

FIG. 2 is an enlarged, perspective view of a gripper bar with open grippers;

FIG. 3 is a perspective view of a gripper bar with closed grippers;

FIG. 4 is a further perspective view of a gripper bar with closed grippers;

FIG. 5 is a further enlarged, cross-sectional view of a gripper bar; and

FIGS. 6 and 7 are respective cross-sectional and perspective views of a gear mechanism controlling the grippers.

### DETAILED DESCRIPTION OF THE INVENTION

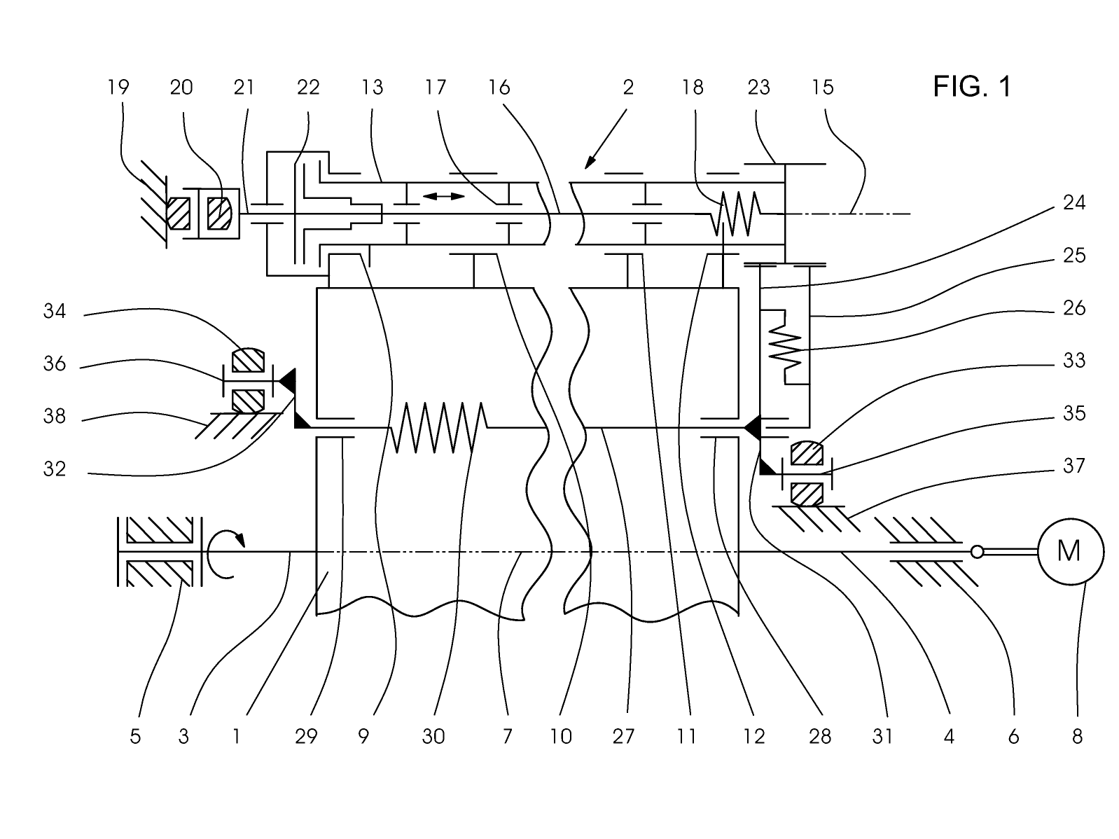

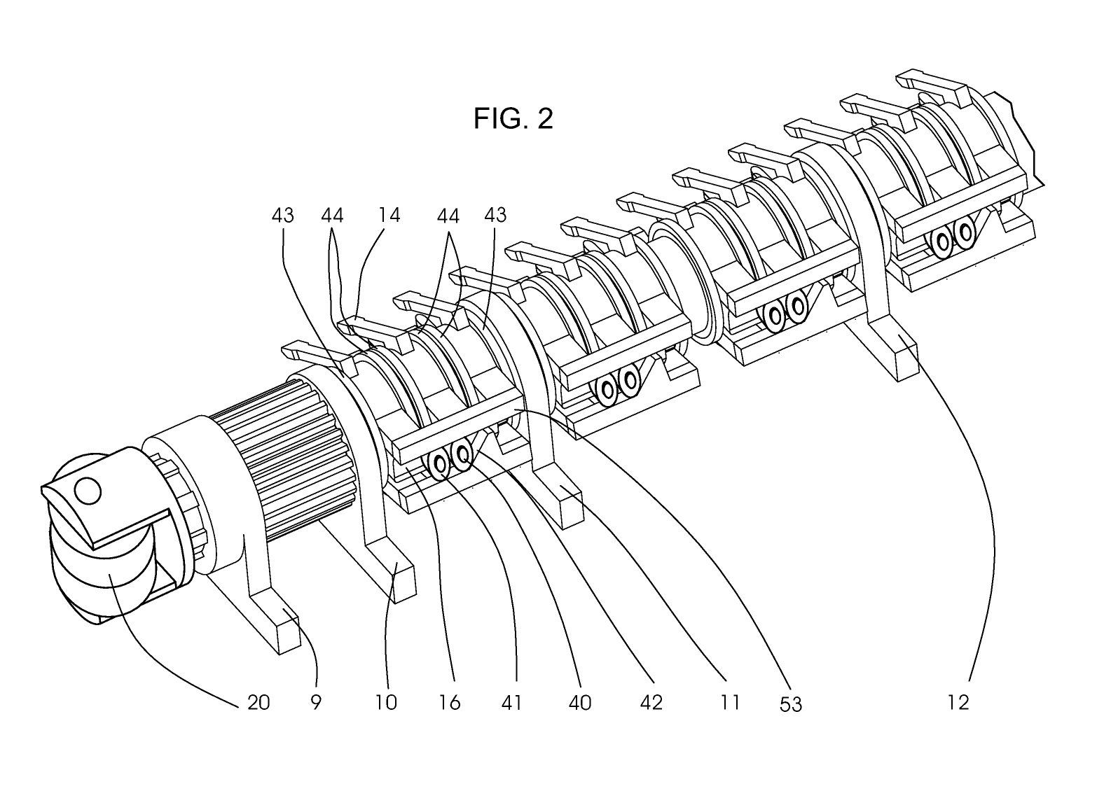

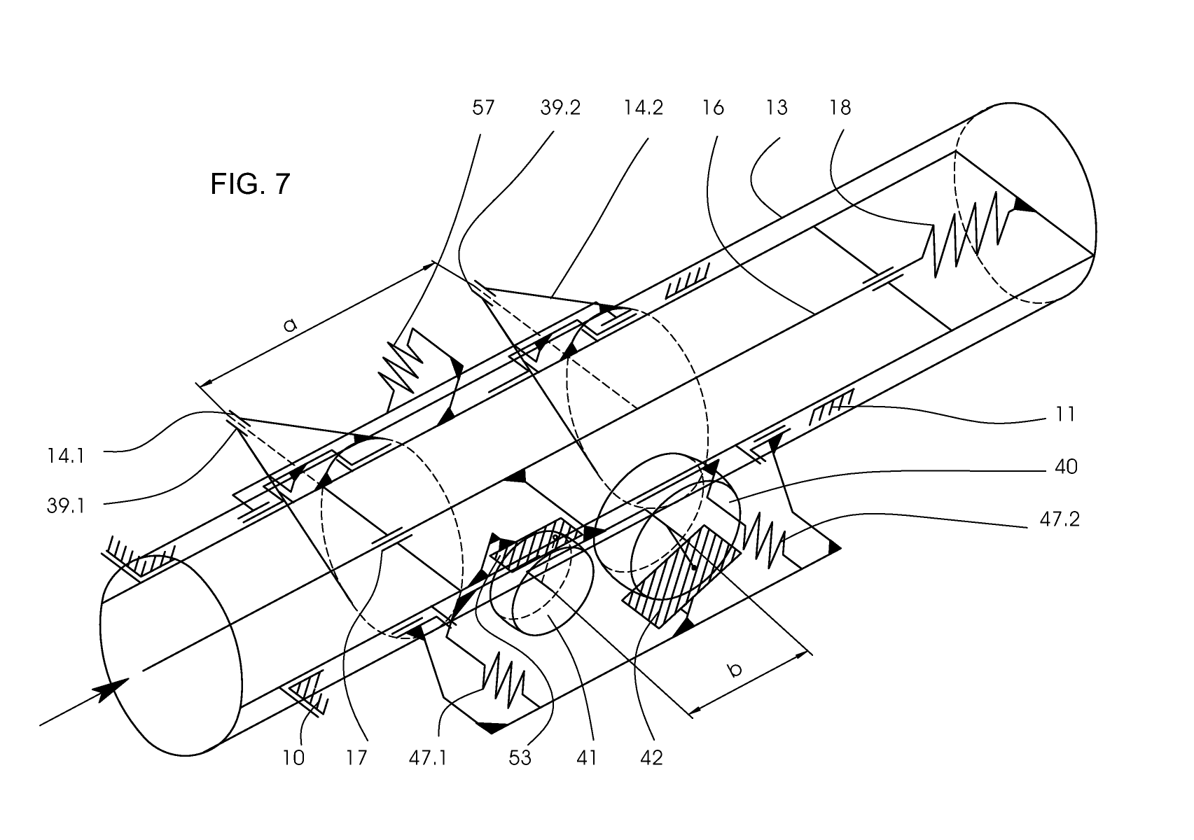

Referring now to the figures of the drawings in detail and first, particularly, to FIG. 1 thereof, there is seen a diagrammatic representation of a reversing or turning drum 1 equipped with a gripper bar 2. The reversing drum 1 is supported in side walls 5, 6 of a sheet-fed printing press through the use of journals 3, 4. A motor 8 drives the reversing drum 1 to rotate about its axis of rotation 7. The gripper bar 2 is supported on the drum body of the reversing drum 1 by pedestal bearings or vertical bearings 9-12. The gripper bar 2 includes a gripper tube 13, among other elements. First gripper fingers 14 (see FIGS. 2-6) of pairs of gripper fingers are fixed to the gripper tube 13 at a distance a (see FIG. 7) from each other. The gripper tube 13 is pivotable about an axis 15 which is parallel to the axis 7.

An actuating shaft 16 is used to open and close the gripper finger pairs. The actuating shaft 16 is displaceable against the force of a compression spring 18 in longitudinal guides 17 in the direction of the axis 15 within the gripper tube 13. An axial cam 19 is disposed on the side wall 5. A cam roller 20 is in contact with the axial cam 19. The cam roller 20 is supported on a follower 21 which is supported on an axial bearing 22 on an actuating shaft end facing away from the spring 18. The follower 21 is secured against rotation with respect to the vertical bearing 9 to ensure that the cam roller is always oriented in the circumferential direction of the drum 1.

The pairs of gripper fingers 14 are jointly pivotable about the axis 15. In order to initiate this pivoting movement, a pinion 23 is attached to the gripper tube 13. The pinion meshes without play with toothed segments 24, 25 tensioned against each other by a spring 26. The toothed segment 24 is attached to a shaft 27 which is supported to pivot in bearings 28, 29 on the drum body of the reversing drum 1. The pivoting axis of the shaft 27 is parallel to the axis 7. The shaft 27 acts as a torsion spring 30. Roller levers 31, 32 are provided on ends of the shaft 27 so as to be fixed against rotation. Cam rollers 33, 34 have axes of rotation 35, 36 which are parallel with the axis 7 and are supported on the roller levers 31, 32. The cam rollers 33, 34 run on radial cams 37, 38 which are fixed to the frame and have substantially the same cam characteristics. The torsion spring 30 prevents the cam rollers 33, 34 from disengaging and compensates for differences in the shape of the radial cams 37, 38.

FIGS. 2-7 illustrate the opening and closing of the pairs of gripper fingers 14, 39 through the use of the axial cam 19. The pairs of gripper fingers 14, 39 are opened and closed in groups. Two or three pairs of grippers belong to a group. One and two groups of pairs of gripper fingers are disposed between the vertical bearings 10, 11 and 11, 12. Rollers 40, 41, having axes of rotation which are disposed at a distance b (see FIG. 7) from each other and are perpendicular to the axis 15, are fixed to the actuating shaft 16 to operate the gripper fingers 14, 39 of a group.

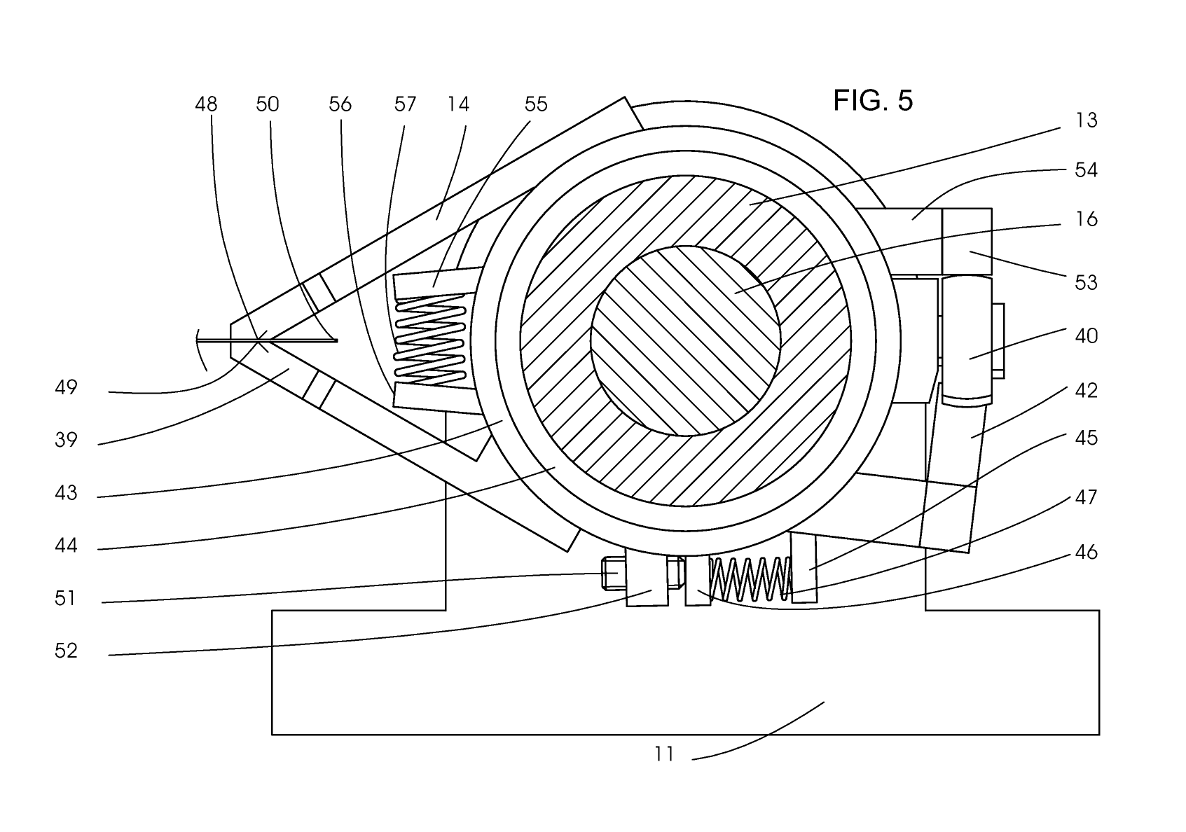

The roller 40 is in engagement with a cam 42 which has two sections of different cam gradients. The cam 42 is formed on sleeves 43 which are supported on the gripper tube 13 so as to pivot about the axis 15. The gripper fingers 39 are attached to a sleeve 44 which is likewise supported on the gripper tube 13 so as to pivot about the axis 15. As is seen in FIG. 5, radial supports 46 are formed on the sleeves 43 and supports 45 and 52 are formed on the sleeves 44. An adjustable stop screw 51 is screwed into a support 52. A pre-tensioned compression spring 47, which is disposed between the supports 45 and 46, is used to rotate the sleeves 43 and 44 relative to each other about the axis 15. As long as the spring 47 does not build up any gripper closing force between gripping surfaces 48, 49, the support 46 rests against the stop screw 51. The screw 51 can be used to adjust the closing instants of the grippers. If the gripping surfaces 48, 49 clamp the edge of a sheet 50, a gap forms between the screw 51 and the support 46.

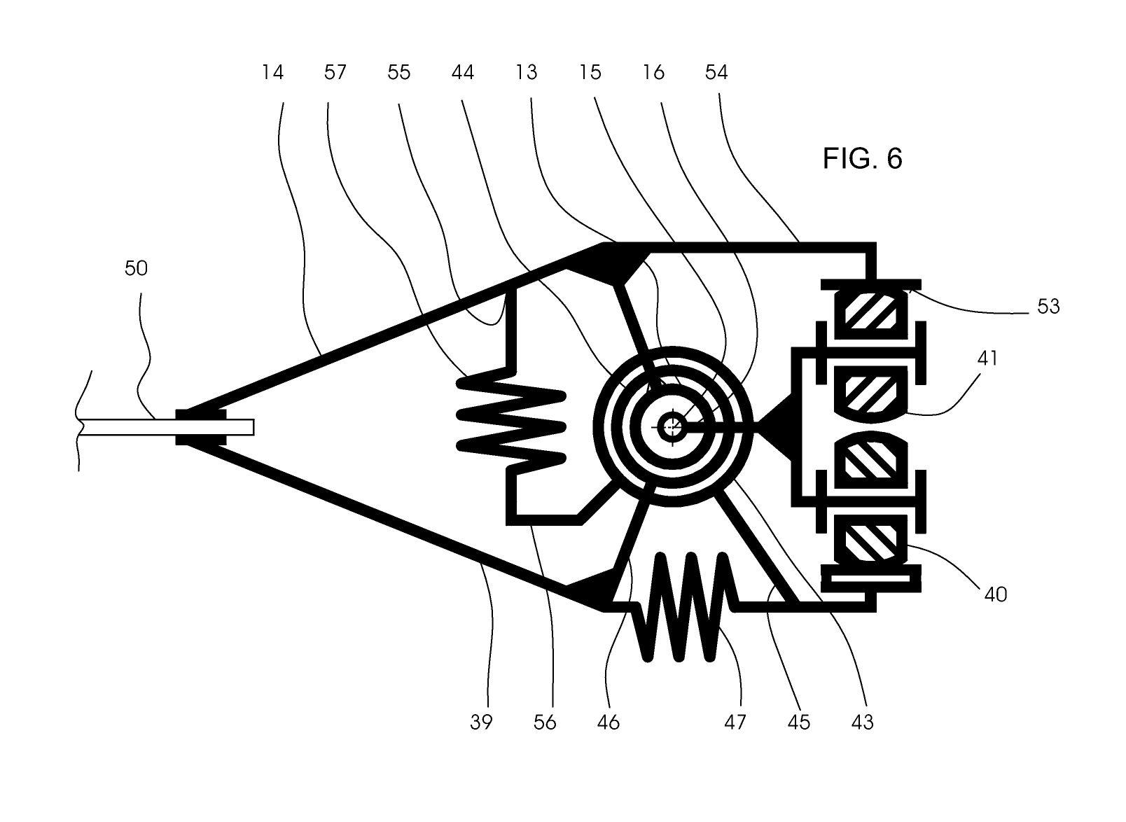

As is seen in FIG. 6, the roller 41 rolls on a race 53 formed on an arm 54 which is connected to the gripper tube 13 so as to be fixed against rotation relative to the gripper tube 13. Further supports 55, 56 are formed on the gripper tube 13 and on the sleeve 43. A tensioned compression spring 57 is provided between these further sleeves 55, 56. The compression spring 57 prevents the rollers 40, 41 from disengaging from the cam 42 and from the race 53.

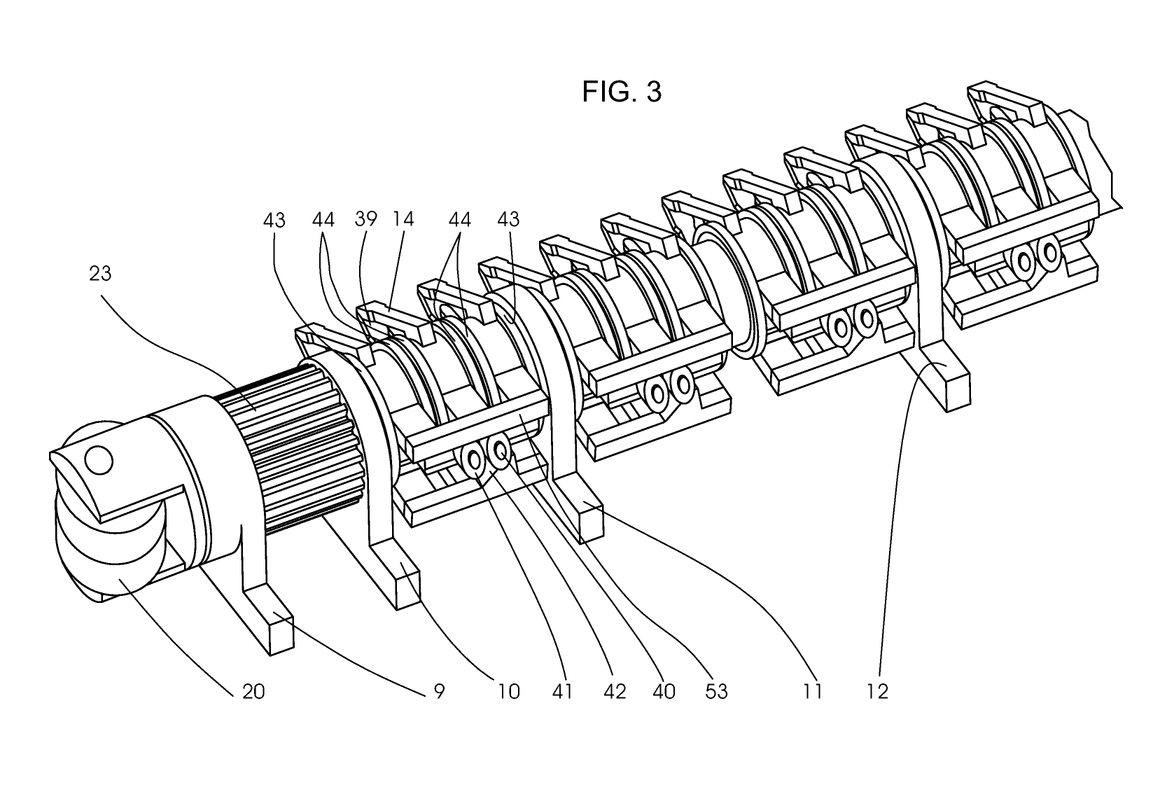

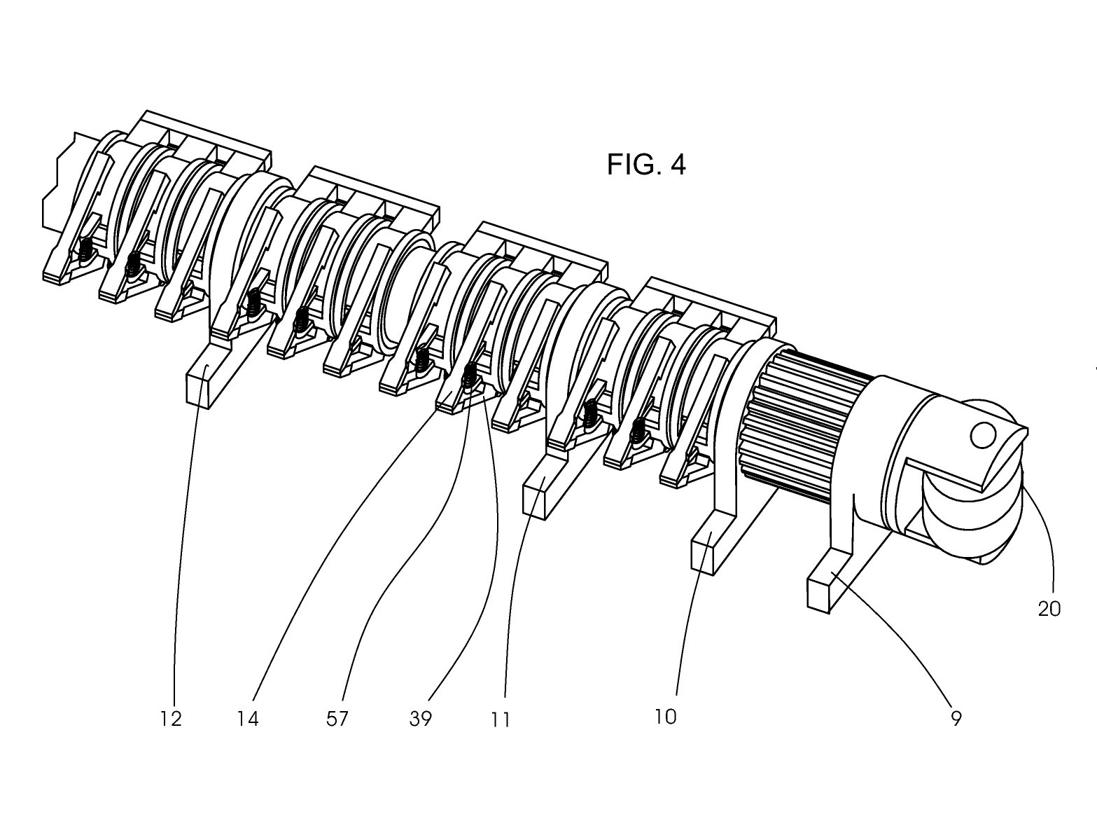

FIG. 2 illustrates the actuating shaft 16 in an extended position in which the grippers are open. As is shown in FIG. 3, the actuating shaft 16 has retracted into the gripper bar 2 so that the grippers are closed. FIG. 4 illustrates a further perspective view of the closed grippers.

An advantage of the fact that several grippers are actuated in groups is that fewer cam joints 40, 41, 42, 53 are required. Due to the use of two cam races 42 and 53 and two rollers 40, 41 per group of jointly driven grippers, the gripper closing forces acting on the gripper fingers 14 are directly absorbed by the opposing gripper fingers 39. Thus, no torsion is applied to the actuating shaft 16 and the gripper tube 13. As a result, high gripper closing forces are possible, thus reducing the danger of gripper oscillation and of undesired opening of the gripper fingers 14, 39 when rigid sheets 50 are deflected. The gripper forces build up abruptly due to the low resilience of the mechanical elements. The actuating shaft 16 is only subjected to pressure, which means that only small material cross sections are required and the gripper tube 13 and the sleeves 43, 44 can be constructed to be correspondingly rigid. The gripper fingers 14 are only slightly deformed as they close, a fact which simplifies the adjustment of the radial gripper height.

1. A transfer drum for conveying a sheet in a printing press, the transfer drum comprising:
a drum body being supported for rotation in a frame and having an axis of rotation;
a gripper system disposed on said drum body for holding an edge of the sheet, said gripper system being formed of a row of spaced-apart gripper fingers jointly pivotable about a pivot axis parallel to said axis of rotation of said drum body; and
a device for actuating said gripper fingers during a revolution of said drum body;
said device for actuating said gripper fingers including an actuating element displaceable in direction of said pivot axis, and cam joints having at least two drive elements formed on said actuating element, each of said drive elements being in operative connection with a respective group of said gripper fingers.

2. The transfer drum according to claim 1, wherein said cam joints include cam elements acting as output elements, and said drive elements are engagement elements engaging said cam elements.

3. The transfer drum according to claim 2, which further comprises a gripper tube, said cam joints including a guide element having a race, and said engagement elements including a first engagement element interacting with one of said cam elements and a second engagement element resting against said race of said guide element connected to said gripper fingers attached to said gripper tube, for each group of said gripper fingers.

4. The transfer drum according to claim 2, wherein said engagement elements are rollers.

5. The transfer drum according to claim 2, wherein each of said cam elements has two regions with different cam gradients.

6. The transfer drum according to claim 2, which further comprises at least one compression spring for opening said gripper fingers of each respective group of said gripper fingers.

7. The transfer drum according to claim 6, wherein said gripper system is a pliers-type gripper system having a gripper tube, said gripper fingers interact in pairs and are fixed to said gripper tube so as to pivot about said gripper tube, and said compression springs are disposed diametrically opposite said engagement elements relative to said pivot axis.

8. The transfer drum according to claim 1, which further comprises an axial cam joint having an output element, said actuating element being coupled to said output element.

9. The transfer drum according to claim 8, wherein said output element includes a cam roller, and a compression spring keeps said cam roller in engagement with an axial curve fixed to the frame.
